(19) United States
(12) Patent Application Publication
(10) Pub. No.: US 2008/0254844 A1
(43) Pub. Date: Oct. 16, 2008

(54) LINK ASSEMBLY WITH SPRINGS WHICH CAN BE EXTENDED AND CONTRACTED AND SLIDER ASSEMBLY FOR SLIDING TYPE MOBILE PHONE HAVING THE LINK ASSEMBLY

(75) Inventor: Jang-Woo Lee, Suwon-Si (KR)

Correspondence Address: KNOBBE MARTENS OLSON & BEAR LLP, 2040 MAIN STREET, FOURTEENTH FLOOR, IRVINE, CA, 92614, US

(73) Assignee: HITECH PARTS CO., LTD., SEOUL (KR)

(21) Appl. No.: 12/052,585

(22) Filed: Mar. 20, 2008

Related U.S. Application Data
(63) Continuation of application No. PCT/KR2006/003593, filed on Sep. 8, 2006.

(30) Foreign Application Priority Data
Sep. 29, 2005 (KR) 10-2005-0090987

(51) Int. Cl. H04M 1/00

(52) U.S. Cl. 455/575.4

(57) ABSTRACT

Disclosed is a link assembly which includes a spring, a first link plate and a second link plate. The spring is formed with catching portions with a reduced outer diameter at both ends thereof. The first link plate includes one widthwise extending side that is formed with a spring fixing groove into which the catching portion positioned at one end of the spring is inserted and fixed. The second link plate includes one widthwise extending side that is formed with another spring fixing groove into which another catching portion positioned at the other end of the spring is inserted and fixed. Further, the first and second link plates are slid with respect to each other.

### CROSS-REFERENCE TO RELATED PATENT APPLICATIONS

This application is a continuation application under 35 U.S.C. § 365(c) of International Application No. PCT/KR2006/003593, filed Sep. 8, 2006 designating the United States. International Application No. PCT/KR2006/003593 was published in English as WO2007/037596 A1 on Apr. 5, 2007. This application further claims the benefit of the earlier filing date under 35 U.S.C. § 365(b) of Korean Patent Application No. 10-2005-0090987 filed Sep. 29, 2005. This application incorporates herein by reference the International Application No. PCT/KR2006/003593 including the International Publication No. WO2007/037596 A1 and the Korean Patent Application No. 10-2005-0090987 in their entirety.

### BACKGROUND

1. Field

The present disclosure relates to a slider assembly, and more particularly, to a slider assembly for use in a handheld electronic device including a sliding-type mobile phone.

2. Discussion of the Related Technology

FIG. 12 shows a link assembly having a pair of link plates for use in a slider assembly for a sliding-type mobile phone, which has been disclosed in Korean Utility Model Registration No. 20-0363295. A link assembly 300 shown in FIG. 12 uses a pair of link plates 310 and a pair of tension springs 320 to improve durability, instead of torsion springs which are used to maintain an up/down state of a sliding plate of the sliding-type mobile phone. The pair of link plates 310 have an identical shape and are restrained by guide protrusions 313 inserted into guide grooves 312 such that they can be slid with respect to each other. The pair of tension springs 320 are hooked to spring engaging portions 314 formed at opposite ends of the link plates 310. Each hinge portion 311 of the link plate 310 formed with a through hole is pinned to a fixing or sliding plate such that the link plate 300 can be rotated with respect to the fixing or sliding plate.

The link assembly 300 so configured has the following problems: That is, the spring engaging portions 314 of the link plate 310 are thin and long enough to be frequently bent and are difficult to fabricate due to their weak strength. Further, additional parts such as the guide protrusion 313 are required to restrain the link plates such that the plates can be slid with respect to each other. In addition, since the ends of the tension springs 320 formed with annular rings are hooked and assembled to the spring engaging portions 314, it is difficult to assemble the link assembly. Furthermore, when the ring hooked to the spring engaging portion 314 of each link plate 310 is moved, it interferes with a flexible printed circuit board (FPCB) of a mobile phone to allow the FPCB to be damaged. In particular, since the ring of the spring is large, the link assembly is thick such that the mobile phone cannot be thin or slim.

The foregoing discussion is to provide general background information, and does not constitute an admission of prior art.

### SUMMARY

An aspect of the present invention is to provide a link assembly and a slider assembly for a sliding-type mobile phone having the link assembly. Another aspect of the present invention is to provide a link assembly and a slider assembly for a sliding-type mobile phone having the link assembly wherein the number of parts is reduced to allow the link assembly to be easily assembled, a coupling structure between springs and link plates is improved to prevent the springs from interfering with a flexible printed circuit board, and the link assembly can be fabricated in a thin structure.

According to an aspect of the present invention, there is provided an extensible link assembly which comprises a spring, a first link plate and a second link plate. The spring is formed with catching portions with a reduced outer diameter at both ends thereof. The first link plate includes one widthwise extending side that is formed with a spring fixing groove into which the catching portion positioned at one end of the spring is inserted and fixed. The second link plate includes one widthwise extending side that is formed with another spring fixing groove into which another catching portion positioned at the other end of the spring is inserted and fixed. Further, the first and second link plates are slid with respect to each other in a state where one surface of the first link plate faces one surface of the second link plate, and are restrained and coupled such that the spring can be stretched as the other sides of the first and second link plates come close to each other in a longitudinal direction.

Preferably, a guide groove into which the other side of the second link plate is inserted in a longitudinal direction is formed at a surface of the one side of the first link plate, and a guide groove into which the other side of the first link plate is inserted in a longitudinal direction is formed at a surface of the one side of the second link plate. Further, the first and second link plates are slid in the longitudinal direction by means of the guide grooves of the first and second link plates. Therefore, the link assembly can be manufactured to be thinner and slimmer.

More preferably, each of the first and second link plates is configured in such a manner that separation preventing grooves are formed in a longitudinal direction at both sides of breadth on the other surface of the other side thereof, and separation preventing protrusions are formed on the one surface of the one side thereof. In such a case, to prevent the first and second link plates from being separated from each other, the separation preventing protrusions of the first link plate are coupled with the separation preventing grooves of the second link plate and the separation preventing grooves of the first link plate are coupled with the separation preventing protrusions of the second link plate.

In order to prevent the spring from being compressed, the first and/or second link plates may further include a sliding motion limiting member for limiting a sliding motion of one of the first and second link plates against the other link plate. Further, the sliding motion limiting member may be coupled with the separation preventing grooves of the opposite link plate to limit the sliding motion.

More preferably, the first and second link plates are formed with through holes at the other sides thereof. The aforementioned link assembly may be coupled with the fixing and sliding plates for the sliding-type mobile phone by means of the through holes.

According to another aspect of the present invention, there is provided a slider assembly for a sliding-type mobile telephone which comprises a fixing plate, a sliding plate and a link assembly. The fixing plate has a guide portion for guiding a linear motion of the sliding plate and is fixed to one surface of a main body of the sliding-type mobile phone. The sliding plate is fixed to an opposite surface of a cover of the sliding-type mobile phone opposite to the one surface of the main body and is guided by the guide portion of the fixing plate to perform the linear motion. The link assembly is extensible and is rotatably coupled with the fixing and sliding plates such that the sliding plate can be linearly moved with respect to the fixing plate due to the extension/compression and restoration of a spring. In order to cause the sliding plate to linearly move relative to the fixing plate, the link assembly comprises a spring, a first link plate and a second link plate. An outer diameter of the spring is reduced at both ends thereof. The first link plate includes one widthwise extending side formed with a spring fixing groove into which a catching portion positioned at one end of the spring is inserted and fixed, and the other side thereof formed with a through hole through which the first link plate is rotatably fixed to the fixing plate. The second link plate includes one widthwise extending side formed with another spring fixing groove into which another catching portion positioned at the other end of the spring is inserted and fixed, and the other side thereof formed with another through hole through which the second link plate is rotatably fixed to the sliding plate. Further, the first and second link plates are slid with respect to each other in a state where one surface of the first link plate faces one surface of the second link plate, and restrained and coupled such that the spring can be stretched as the other sides of the first and second link plates come close to each other in a longitudinal direction.

Preferably, a guide groove into which the other side of the second link plate is inserted in a longitudinal direction is formed at a surface of the one side of the first link plate, and a guide groove into which the other side of the first link plate is inserted in a longitudinal direction is formed at a surface of the one side of the second link plate. Further, the first and second link plates are slid in the longitudinal direction by means of the guide grooves of the first and second link plates.

More preferably, each of the first and second link plates is configured in such a manner that separation preventing grooves are formed in a longitudinal direction at both sides of breadth on the other surface of the other side thereof, and separation preventing protrusions are formed on the one surface of the one side thereof. In such a case, to prevent the first and second link plates from being separated from each other, the separation preventing protrusions of the first link plate are coupled with the separation preventing grooves of the second link plate and the separation preventing grooves of the first link plate are coupled with the separation preventing protrusions of the second link plate.

In order to prevent the spring from being compressed, the first and/or second link plates may further include a sliding motion limiting member for limiting a sliding motion of one of the first and second link plates against the other link plate. Further, the sliding motion limiting member may be coupled with the separation preventing grooves of the opposite link plate to limit the sliding motion.

According to a further aspect of the present invention, there is provided a link assembly which comprises a plurality of springs, a first link plate and a second link plate. The first link plate includes a plurality of receiving grooves which are formed substantially in parallel with one another by a predetermined length in a longitudinal direction from one end on one surface thereof to accommodate one ends of the springs. The second link plate includes a receiving groove which is formed in the longitudinal direction from one end on one surface thereof to accommodate the other ends of the springs. Further, the first and second link plates are slid with respect to each other in a state where the one surface of the first link plate faces the one surface of the second link plate, and restrained and coupled such that the spring can be compressed as the other sides of the first and second link plates come close to each other in a longitudinal direction. When the springs are compressed, they may be buckled. The receiving grooves prevent the springs from being buckled.

Preferably, the first link plate is formed with supporting protrusions each of which is inserted into the one end of the spring and the second link plate is formed with supporting protrusions each of which is inserted into the other end of the spring. Further, one and the other ends of the springs are restrained by means of the supporting protrusions.

Further, the link assembly of the present invention may include supporting grooves instead of the supporting protrusions to restrain both ends of the springs. In such a case, the first link plate is formed with the supporting grooves into which the one ends of the springs are inserted, and the second link plate is formed with supporting grooves into which the other ends of the springs are inserted. That is, one and the other ends of the springs are restrained by means of the supporting grooves.

More preferably, each of the first and second link plates is configured in such a manner that guide groove and wing are formed at one lateral side and the other side thereof along the longitudinal direction, respectively. The guide wing of the first link plate is inserted into the guide groove of the second link plate such that the second link plate can be slid with respect to the first link plate along the longitudinal direction of the first link plate by means of the coupling between the guide wing and groove. Furthermore, the guide wing of the second link plate is inserted into the guide groove of the first link plate.

More preferably, each of the first and second link plates includes a guide hole formed in the guide groove along the longitudinal direction by a predetermined length and a guide protrusion protruding from the guide wing. The guide protrusion of the first link plate is inserted into the guide hole of the second link plate, and the guide protrusion of the second link plate is inserted into the guide hole of the first link plate.

The first and second link plates are preferably formed with through holes at the other ends thereof. The aforementioned link assembly can be coupled with the fixing and sliding plates of the slider assembly for a sliding-type mobile phone by means of the through holes.

According to a still further aspect of the present invention, there is provided a slider assembly for a sliding-type mobile telephone which comprises a fixing plate, a sliding plate and a link assembly. The fixing plate includes a guide portion for guiding a linear motion of a sliding plate and is fixed to one surface of a main body of the sliding-type mobile phone. The sliding plate is fixed to an opposite surface of a cover of the sliding-type mobile phone opposite to the one surface of the main body and is guided by the guide portion of the fixing plate to perform the linear motion. The link assembly is extensible and is rotatably coupled with the fixing and sliding plates such that the sliding plate can be linearly moved with respect to the fixing plate due to extension/compression and restoration of a spring. In order to cause the sliding plate to linearly move relative to the fixing plate, the link assembly comprises a plurality of springs, a first link plate and a second link plate. The first link plate includes a plurality of receiving grooves formed substantially in parallel with one another by a predetermined length in a longitudinal direction from one end on one surface thereof to accommodate one ends of the springs, and a through hole formed at the other end thereof to allow the first link plate to be rotatably fixed to the fixing plate. The second link plate includes a receiving groove formed in the longitudinal direction from one end on one surface thereof to accommodate the other ends of the springs, and a through hole formed at the other end thereof to allow the second link plate to be rotatably fixed to the sliding plate. Further, the first and second link plates are slid with respect to each other in a state where the one surface of the first link plate faces the one surface of the second link plate, and restrained and coupled such that the spring can be compressed as the other sides of the first and second link plates come close to each other in a longitudinal direction.

Preferably, the first link plate is formed with supporting protrusions each of which is inserted into the one end of the spring and the second link plate is formed with supporting protrusions each of which is inserted into the other end of the spring. Further, one and the other ends of the springs are restrained by means of the supporting protrusions.

Further, the slider assembly for a sliding-type mobile phone of the present invention may include supporting grooves instead of the supporting protrusions to restrain both ends of the springs. In such a case, the first link plate is formed with the supporting grooves into which the one ends of the springs are inserted, and the second link plate is formed with supporting grooves into which the other ends of the springs are inserted. That is, one and the other ends of the springs are restrained by means of the supporting grooves.

More preferably, each of the first and second link plates is configured in such a manner that guide groove and wing are formed at one lateral side and the other side thereof along the longitudinal direction, respectively. The guide wing of the first link plate is inserted into the guide groove of the second link plate such that the second link plate can be slid with respect to the first link plate along the longitudinal direction of the first link plate by means of the coupling between the guide wing and groove. Furthermore, the guide wing of the second link plate is inserted into the guide groove of the first link plate.

More preferably, each of the first and second link plates includes a guide hole formed in the guide groove along the longitudinal direction by a predetermined length and a guide protrusion protruding from the guide wing. The guide protrusion of the first link plate is inserted into the guide hole of the second link plate, and the guide protrusion of the second link plate is inserted into the guide hole of the first link plate.

### BRIEF DESCRIPTION OF THE DRAWINGS

FIG. 1 is a perspective view of an embodiment of an extensible link assembly according to the present invention.

FIG. 2 is an exploded perspective view of FIG. 1.

FIG. 3 is a sectional view taken along line A-A of FIG. 2.

FIG. 4 is an exploded perspective view of an embodiment of a slider assembly for a mobile phone having the link assembly of FIG. 1.

FIG. 5 is views illustrating an operational state of the slider assembly shown in FIG. 4.

FIG. 6 is a perspective view of another embodiment of an extensible link assembly according to the present invention.

FIG. 7 is an exploded perspective view of FIG. 6.

FIG. 8 is a sectional view taken along line A-A of FIG. 6.

FIG. 9 is an exploded perspective view of an embodiment of a slider assembly for a mobile phone having the link assembly of FIG. 6.

FIG. 10 is a view illustrating an operational state of the slider assembly shown in FIG. 9.

FIG. 11 is a sectional view of the link assembly shown in FIG. 6 in which another spring restraining means is used.

FIG. 12 is a perspective view of an extensible link assembly.

Listing of Some Reference Numerals

| | |
|---|---|
| 700: slider assembly | 710: fixing plate |
| 711: hinge hole | 712, 712′: fixing grooves |
| 713, 713′: guide portion | 714, 714′: guide bush |
| 720: sliding plate | 721: hinge hole |
| 722, 722′: bent portion | 723, 723′: wing portion |
| H: fixing pin | 800: up/down keeping means |
| 810: link slider | 820: spring fixing portion |
| 821: link groove | 823: guide jaw |
| 824: spring fixing groove | 830: link portion |
| 831: guide groove | 832: hinge groove |
| 833: catching jaw | 840: spring |

### DETAILED DESCRIPTION OF EMBODIMENTS

First, a link assembly and a slider assembly for a sliding-type mobile phone having the link assembly according to an embodiment of the present invention will be described in detail.

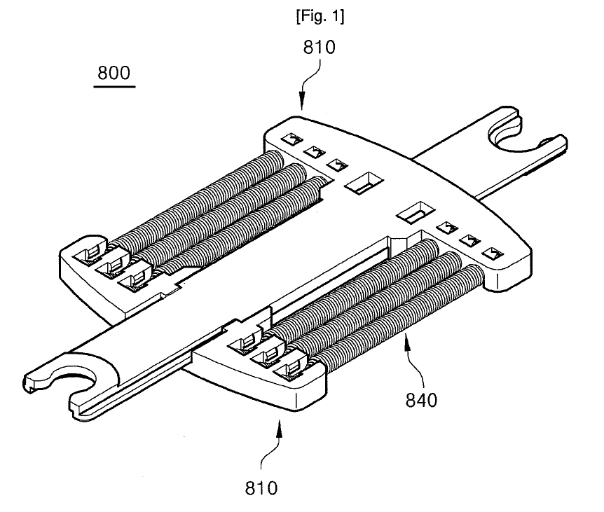

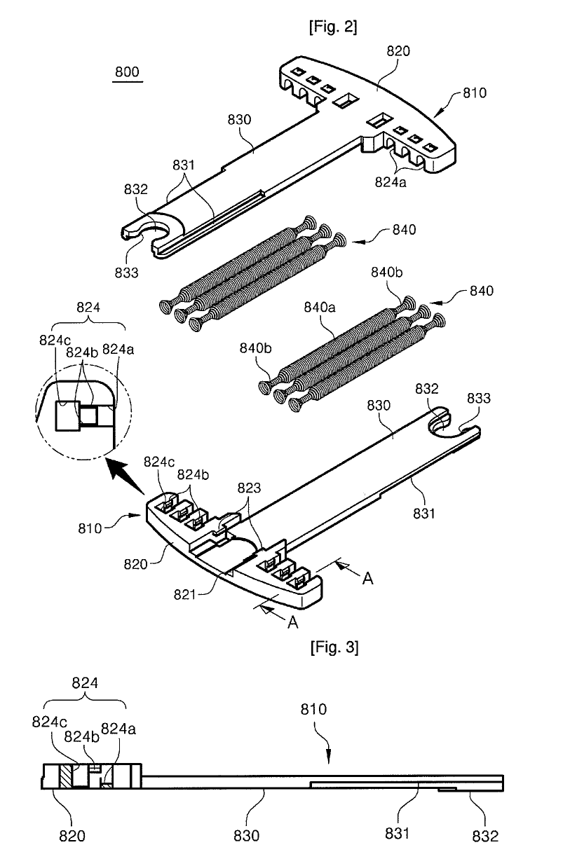

In an embodiment of the present invention, tension springs are used in the link assembly. FIG. 1 is a perspective view of an embodiment of an extensible link assembly according to an embodiment of the present invention, FIG. 2 is an exploded perspective view of FIG. 1, and FIG. 3 is a sectional view taken along line A-A of FIG. 2.

The link assembly shown in FIG. 1 is an embodiment of a link assembly in which tension springs are employed. A link assembly 800 according to this embodiment of the present invention comprises a pair of link plates 810 each of which has an identical shape in such a manner that one surface thereof faces one surface of the other link plate and the link plates are restrained to be slidable with respect to each other, and a plurality of springs 840 each of which has opposite ends fixed to the two link plates 810, respectively. For convenience of explanation, one of the pair of link plates 810 is referred to as a first link plate 810 while the other is referred to as a second link plate 810.

Each of the plurality of springs 840 is formed with catching portions 840b at both ends thereof, and the outer diameter of the catching portion 840b is smaller than that of a central portion 840a of the spring 840. The catching portions 840b formed at both ends of the spring 840 are inserted and fixed into spring fixing grooves 824 of the first and second link plates 810, respectively, which will be described below. In this embodiment of the present invention, the outer diameter of the catching portion installed to the spring fixing groove is formed to be smaller than that of the central portion of the spring, and vice versa.

Each of the link plates 810 is shaped as a plate and comprises an elongated link portion 830 and a spring fixing portion 820.

One end of the link portion 830 is formed with a through hole 832 into which a fixing pin H is inserted. When the fixing pin H is inserted into the through hole 832, the link portion 830 can be pivoted about the fixing pin H. One side of the through hole 832 is open such that the fixing pin H can be easily fastened into and unfastened from the through hole 832. On the inner surface of the open side is formed a catching jaw 833 for preventing the link assembly 800 from being separated from the fixing pin H of the link plate when the link assembly 800 is slid. Further, the link portion 830 has separation preventing grooves 831 formed on both sides of the other surface in a longitudinal direction.

The spring fixing portion 820 extends in a lateral direction at the other end of the link portion 830 such that it is integrally formed with the link portion 830. Further, a plurality of spring fixing grooves 824 into which the spring catching portions 840b are inserted and fixed are formed at regular intervals in one surface of the spring fixing portion 820 which faces to an opposite surface of the spring fixing portion 820 of the other link plate 810. Each of the spring fixing grooves 824 is composed of a receiving portion 824c which receives one end of the spring 840 to allow the catching portion 840b of the spring 840 to be fixed thereto, a fixing portion 824b to which the catching portion 840b is caught not to be separated therefrom, and a guide portion 824a which extends slightly toward the central portion 840a of the springs 840. Therefore, the catching portions 840b formed at both ends of the spring 840 can be easily fixed into the corresponding spring fixing grooves 824 of the spring fixing portions 820, respectively. Since the catching portion 840b of the spring 840 is fixed into the fixing portions 824b of the spring fixing grooves 824, it is possible to prevent the springs 840 from being separated from the spring fixing grooves 824.

Further, in the middle portion of one surface of the spring fixing portion 820 of the first link plate 810 is formed a guide groove 821 through which the link portion 830 of the second link plate 810 can be slid in a longitudinal direction. In order to prevent the first link plate 810 and the second link plate 810 from being separated from each other when the link portion 830 of the second link plate 810 is slid along the guide groove 821 of the first link plate 810, guide jaws 823 which are engaged with the separation preventing grooves 831 of the second link plate 810 are formed on both side surfaces of the guide groove 821 of the first link plate 810, respectively. Since the first link plate 810 and the second link plate 810 have the same shape as each other, the guide jaws 823 are also formed in the spring fixing portion 820 of the second link plate 810.

Hereinafter, an operating state of the link assembly 800 according to an embodiment of the present invention will be described in brief. The maximum distance that a pair of link plates 810 can be slid with respect to each other is determined by tensile force of the plurality of springs 840. If a user causes a sliding plate 720 to be slid, the plurality of springs 840 of the link assembly 800 are stretched and each of the link plates 810 fixed by the fixing pin H can thus be rotated about the fixing pin H. While the pair of link plates 810 are rotated and also slid in a direction along which the entire length of the link plates 810 is decreased, the variation in entire length of the link plates 810 due to the sliding motion of the sliding plate 720 can be absorbed. At this time, the tensile force of the spring 840 is maximized while the stretched length of the pair of link plates 810 is minimized.

If the length of the spring 840 is increased as described above and a user continues applying force to the sliding plate 720 to move the sliding plate 720, the sliding plate 720 will be automatically moved toward a force direction due to the elastic energy stored in the springs 840. That is, as the plurality of springs 840 are compressed, the link plates 810 rotatably installed at each end are pulled from each other. Thus, the link plate 810 fixed to the sliding plate 720 causes the sliding plate 720 to be pushed.

As described above, the catching portions 840b formed at both ends of the spring 840 are inserted into the corresponding spring fixing grooves 824 which of the link plates 810 such that the catching portions 840b and the spring fixing grooves 824 can be easily attached to and detached from each other such that convenient assembly can be made. Since rings are formed at both ends of the spring to catch the spring to the exemplary spring engaging portion, the exemplary link assembly cannot be slimly fabricated as a whole. However, since the catching portions 840b formed at both ends of the spring 840 can be inserted into the spring fixing grooves 824, the outer diameter of the spring can be adjusted at a reduced value to allow the link assembly according to an embodiment of the present invention to be fabricated in a slim way.

Meanwhile, if each of the link plates 810 is manufactured by injection molding a plastic having a lower kinetic friction coefficient, the link plates 810 can be smoothly slid with respect to each other and their mass production can be also made. Accordingly, the total manufacturing costs can be reduced.

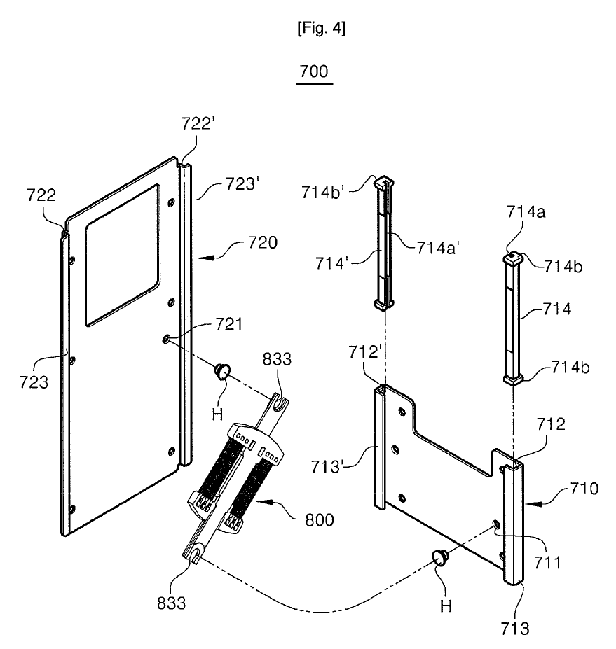

FIG. 4 is an exploded perspective view of an embodiment of a slider assembly for a sliding-type mobile phone having the link assembly according to an embodiment of the present invention.

A slider assembly 700 according to an embodiment of the present invention comprises a fixing plate 710, a sliding plate 720 and a link assembly 800. The fixing plate 710 includes a guide portion for guiding a linear motion and is fixed to one surface of a main body of the sliding-type mobile phone. The sliding plate 720 is guided by the guide portion of the fixing plate 710 such that it can be linearly moved, and it is fixed to one surface of a mobile phone cover opposite to the surface of the main body. The link assembly 800 has one end rotatably supported on the fixing plate 710 and the other end rotatably supported on the sliding plate 720 such that the direction of a pushing force for urging the sliding plate 720 can be changed at a predetermined sliding position of the sliding plate 720. Further, in order to prevent opposite side surfaces of the fixing and sliding plates 710 and 720, which are slid with respect to each other, from being worn away by their frictions, a pair of guide bushes 714 and 714′ are installed into fixing grooves 712 and 712′ of the fixing plate 710, respectively.

In longitudinal guide portions 713 and 713′ on the fixing plate 710 are formed a pair of fixing grooves 712 and 712′ bent twice by a press in parallel and opposite to each other, a plurality of screw holes used to fix the fixing plate to the main body of the mobile phone, and a hinge hole 711 in which the fixing pin H is installed such that the link assembly 800 can be rotated about the fixing pin. Further, the guide bushes 714 and 714′ are installed in the fixing grooves 712 or 712′, respectively. Each of the guide bushes is formed with shock-absorbing protrusions 714b and 714b′ at both longitudinal ends thereof outside of the fixing grooves 712 and 712 and with the guide grooves 714a and 714a′ along which the sliding motions of both lateral sides of the sliding plate 720 can be guided.

The guide bushes 714 and 714′ are used to prevent wing portions 723 and 723′ of the sliding plate 720, which are repeatedly slid against the guide bushes, from being worn away due to the operating friction between the guide bushes 714 and 714′ and the wing portions 723 and 723′, and any material can be used when manufacturing the guide bush 714 and 714′, so long as it is wear resistant enough to be used for a long time without frequent exchange and it has a lower kinetic friction coefficient. Further, the shock-absorbing protrusions 714b and 714b′ are used to absorb shock which may be generated and transferred to the guide bushes 714 and 714′ during the sliding motion in order to prevent the guide bushes 714 and 714′ from being broken due to the transferred shock. It is preferred that the shock-absorbing protrusions 714b and 714b′ be installed to protrude further from both side ends of the fixing plate 710.

The sliding plate 720 includes a plurality of screw holes used to fix the sliding plate 720 to the mobile phone cover, a hinge hole 721 in which the fixing pin H is installed such that the link assembly 800 can be rotated about the fixing pin, bent portions 722 and 722′ bent at both lateral sides thereof toward the fixing plate 710 by a press, and the wing portions 723 and 723′ bent once more to extend to the outside thereof. The pair of wing portions 723 and 723′ are fitted into the guide bushes 714 and 714′ installed in the fixing grooves 712 and 712′ of the fixing plate 710, respectively, such that the wing portions 723 and 723′ can be slid in a longitudinal direction.

As described above, since portions of the through holes 832 of the respective link portions 830 which are rotatably fixed by the fixing pins H of the fixing and sliding plates 710 and 720 are open, the fixing pins H can be easily fastened to or unfastened from the through holes 832. Further, since the catching jaws 833 are formed on the inner surfaces of the open portions of the through holes 832, the link assembly 800 can be prevented from being separated from the fixing pins during the sliding motion.

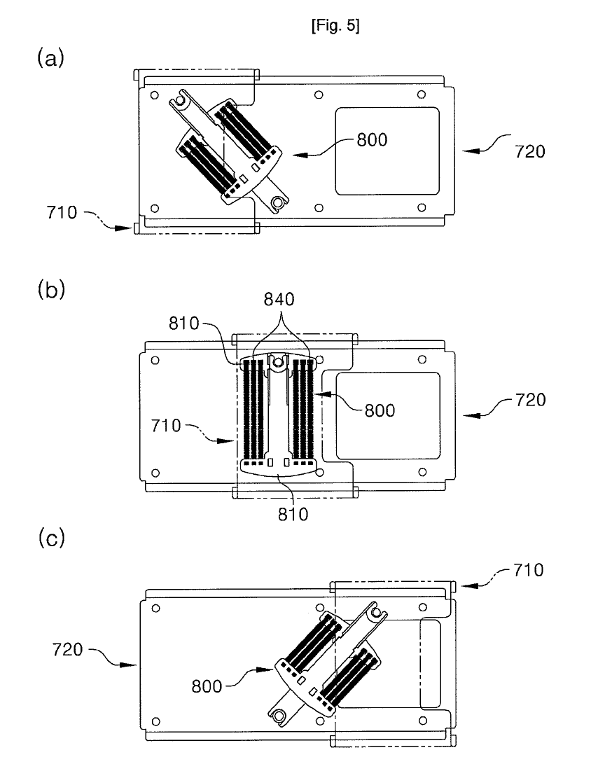

FIG. 5 (a) to (c) are views illustrating an operating state of the slider assembly in an embodiment shown in FIG. 4. Hereinafter, the operation of the slider assembly of the present embodiment will be described.

A state shown in FIG. 5 (a) is a state where the link plates are slid with respect to each other such that the extended length of the restrained link plates can be maximized by tensile force of the springs. If a user pushes the sliding plate 720 leftward, the sliding plate 720 is slid and the springs 840 of the link assembly 800 are thus stretched while the respective hinged link plates 810 are rotated, as shown in FIG. 5 (b). At the same time, as the pair of link plates 810 are slid, an overlapping portion where the separation preventing grooves 831 in the link portions 830 overlap the guide grooves 821 of the spring fixing portions 820 is increased, and the total length of the pair of link plates are thus decreased. At this time, the guide jaws 823 formed in the guide groove 821 are slid along the separation preventing grooves 831 of the link plates 810 such that the pair of link plates 810 cannot be separated from each other. In the state shown in FIG. 5 (b), the tensile force of the springs 840 is maximized while the extended length of the pair of link plates 810 is minimized. Since the length of the spring 840 is increased until the pair of link plates is in a state shown in FIG. 5 (b), the user applies force to move the sliding plate 720. However, if the sliding plate 720 is slightly moved leftward from the state shown in FIG. 5 (b), elastic energy stored in the springs 840 causes the sliding plate 720 to be automatically moved leftward. That is, the plurality of springs 840 are compressed to pull the link plates 810 fixed to both ends of the springs 840 toward each other, and thus, the link plate 810 fixed to the sliding plate 720 causes the sliding plate 720 to be moved toward a state shown in FIG. 5 (c). The sliding motion from the state shown in FIG. 5 (c) to the state shown in FIG. 5 (a) can be performed by repeating the same process as described above.

The link assembly 800 in which a coupling structure between a plurality of springs 840 and a pair of link plates 810 is improved as described above does not interfere with a flexible printed circuit board (FPCB) mounted to the inside of the fixing or sliding plate 710 or 720 when the fixing and sliding plates 710 are slid with respect to each other. Therefore, the fixing and sliding plates can be smoothly operated when they are moved upward and downward.

Next, a link assembly and a slider assembly for the sliding-type mobile phone using the same link assembly according to another embodiment of the present invention will be described in detail. Compression springs are employed in the link assembly according to this embodiment of the present invention.

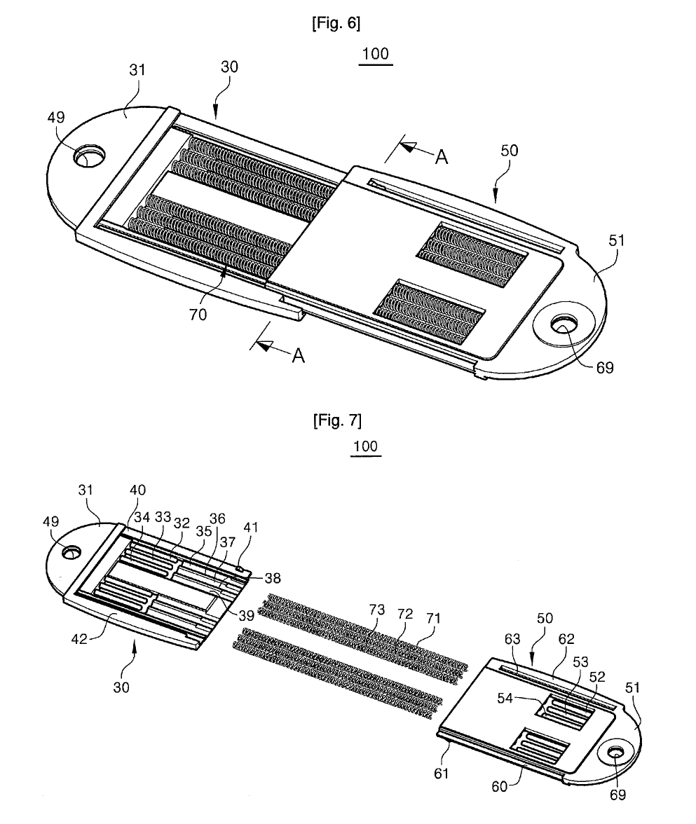

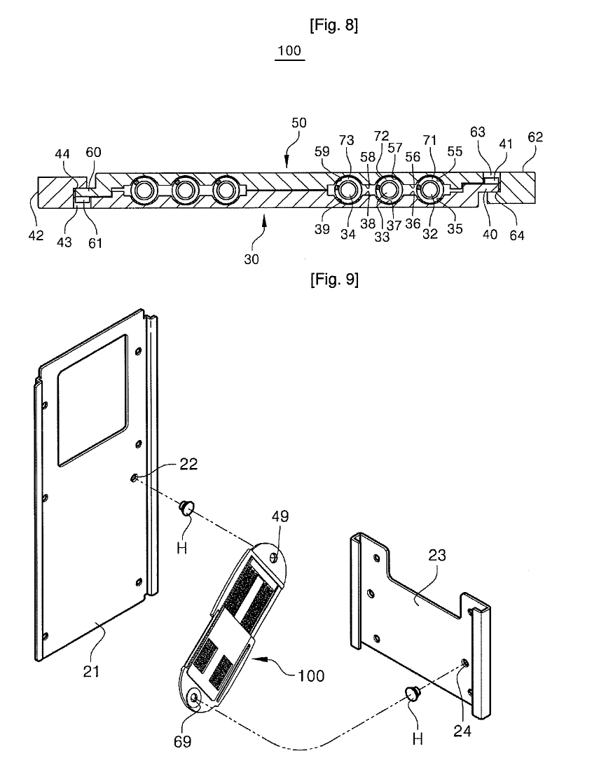

FIG. 6 is a perspective view of an extensible link assembly according to another embodiment of the present invention, FIG. 7 is an exploded perspective view of FIG. 6, and FIG. 8 is a sectional view taken along line A-A of FIG. 6.

A link assembly 100 shown in FIG. 6 comprises a first link plate 30, a second link plate 50 and a plurality of springs 70.

The first link plate 30 includes a plurality of first receiving grooves 35, 37 and 39. Further, the first link plate 30 is formed with a first through hole 49, first supporting protrusions 32, 33 and 34, a first guide wing 40, a first guide groove 44, a first guide hole 43 and a first guide protrusion 41.

In addition, the second link plate 50 includes a plurality of second receiving grooves 55, 57 and 59. Further, the second link plate 50 is formed with a second through hole 69, second supporting protrusions 52, 53 and 54, a second guide wing 60, a second guide groove 64, a second guide hole 63 and a second guide protrusion 61.

The first and second link plates 30 and 50 are coupled with each other such that they can be slid in a longitudinal direction by a predetermined length, and the springs 70 are installed between opposite surfaces of the first and second link plates 30 and 50. Further, the first and second link plates 30 and 50 have an identical shape, and are coupled with each other in an axisymmetric manner. Therefore, only the structure of the first link plate 30 will be described, but the description to the structure of the second link plate 50 will be replaced with that of the first link plate 30.

The structure of the first link plate 30 will be described below. Each of the first receiving grooves 35, 37 and 39 accommodates the spring 70 therein and prevents the spring 70 from being buckled when the spring 70 is compressed. To this end, a plurality of first receiving grooves 35, 37 and 39 are formed on one surface of the first link plate 30 facing the second link plate 50. Further, each of the first receiving grooves 35, 37 and 39 has a diameter larger than the spring 70 to the extent that the spring 70 can be freely stretched and compressed but can be prevented from being buckled when the spring 70 is compressed. In addition, the first receiving grooves 35, 37 and 39 are formed in parallel with each other in a longitudinal direction by a predetermined length from one end of the first link plate 30. Accordingly, the one end of each of the first receiving grooves 35, 37 and 39 is opened and the other end thereof is closed. If the springs 70 are installed in the first receiving grooves 35, 37 and 39, respectively, one ends of the springs 70 are received in the first receiving grooves 35, 37 and 39 while the other ends thereof protrude from the first receiving grooves 35, 37 and 39. As described above, since the first and second link plates 30 and 50 are coupled with each other in the axisymmetric manner, the other ends of the springs 70 are received in the second receiving grooves 55, 57 and 59 of the second link plate 50.

The first through hole 49 is formed in the other end of the first link plate 30 such that the first link plate 30 can be rotatably coupled with the fixing or sliding plate 23 or 21 through the fixing pin H.

Each of the first supporting protrusions 32, 33 and 34 protrudes from the other end of the first receiving groove 35, 37 or 39 such that the one end of the spring 70 can be inserted around the protrusion. Accordingly, the one end of each spring 70 is restrained by the first supporting protrusion 32, 33 or 34.

The first guide wing 40 is formed in the longitudinal direction at a lateral side of the first link plate 30.

The first guide groove 44 is formed along the longitudinal direction at the other lateral side of the first link plate 30 such that the second guide wing 60 of the second link plate 50 can be inserted in the first guide groove. Accordingly, the first guide wing 40 is fitted into the second guide groove 64, and the second guide wing 60 is fitted into the first guide groove 44. The first and second link plates 30 and 50 can be slid in a longitudinal direction and restrained in a relative motion in a lateral direction by means of the mutual coupling between the first and second guide wings 40 and 60 and the first and second guide grooves 44 and 64.

The first guide hole 43 is formed in the first guide wing 40 along the longitudinal direction of the first link plate 30 by a predetermined length.

The first guide protrusion 41 protrudes from the first guide wing 40 and is inserted into the second guide hole 63. Accordingly, the first guide protrusion 41 is inserted into the second guide hole 63 while the second guide protrusion 61 is inserted into the first guide hole 43. The first link plate 30 is slid in the longitudinal direction relative to the second link plate 50. In this case, since the first and second guide protrusions 41 and 61 are inserted respectively into the second and first guide holes 63 and 43, the first link plate 30 can be slid by the length of the first and second guide holes 43 and 63.

Each of the springs 70 is received in the first receiving groove 35, 37 or 39 of the first link plate 30 and the second receiving groove 55, 57 or 59 of the second link plate 50. The first supporting protrusion 32, 33 or 34 is inserted into one end of the spring 70, while the second supporting protrusion 52, 53 or 54 is inserted into the other end of the spring 70. Accordingly, even though the springs 70 are compressed due to the sliding motion of the first and second link plates 30 and 50, the springs 70 are restrained by means of the supporting protrusions such that they cannot be separated from the first and second link plates 30 and 50.

In this embodiment, the first supporting protrusions 32, 33 and 34 and the second supporting protrusions 52, 53 and 54 are used to prevent the springs 70 from be separated, but a variety of embodiments may be implemented. FIG. 11 is another embodiment of preventing the springs from being separated. In an embodiment shown in FIG. 11, first and second link plates 130 and 160 are formed with first and second supporting grooves 132 and 134 instead of the supporting protrusions, respectively. One end of a spring 171 is inserted into the first supporting groove 132 while the other end of the spring 171 is inserted into the second supporting groove 134. Since the two opposite ends of the spring 171 are inserted respectively into the supporting grooves 132 and 134, the separation of the spring 171 is prevented.

FIG. 9 is an exploded perspective view of a slider assembly for a mobile phone having the link assembly shown in FIG. 6.

The slider assembly according an embodiment of the present invention comprises a fixing plate 23 which is fixed to one surface of a main body of the sliding-type mobile phone and formed with a through hole 24, and a sliding plate 21 which is restrained to linearly movable along an inner peripheral surface of the fixing plate 23, is fixed to an opposite surface of a mobile phone cover opposite to the one surface of the main body and is formed with a through hole 22 at a predetermined position. At this time, the link assembly 100 is installed in such a manner that the fixing pin H is first inserted into the first through hole 49 formed in a first link hinge portion 31 of the first link plate 30 and then inserted into the through hole 22 of the sliding plate 21. The first link plate 30 installed as such can be rotated about the fixing pin H during its sliding operation. Further, the fixing pin H inserted into the second through hole 69 of the second link plate 50 is installed into the through hole 24 of the fixing plate 23, and thus, the second link plate 50 can also be rotated about the fixing pin H during its sliding operation.

The operating state of the link assembly 100 according to an embodiment of the present invention will be briefly described. The compression force of the plurality of springs 70 causes the first and second link plates 30 and 50 to be slid and restrained such that the length of the first and second link plates 30 and 50 can be minimized. If a user causes the sliding plate 21 to be slid, the plurality of springs 70 of the link assembly 100 are compressed such that the first and second link plates 30 and 50 fastened to the fixing pin H can be rotated. At the same time, a variation in length of the first and second link plates 30 and 50 due to the sliding motion of the sliding plate 21 can be absorbed since the first and second link plates 30 and 50 can be slid in a direction in which the length of the first and second link plates 30 and 50 is reduced. At this time, the compression force of the springs 70 is maximized and the extended length of the first and second link plates 30 and 50 is minimized.

As described above, if the length of the spring becomes short and the user then continues to apply force to move the sliding plate 21, elastic energy stored in the springs 70 causes the sliding plate 21 to be automatically moved toward in a direction in which the user wishes to push the sliding plate.

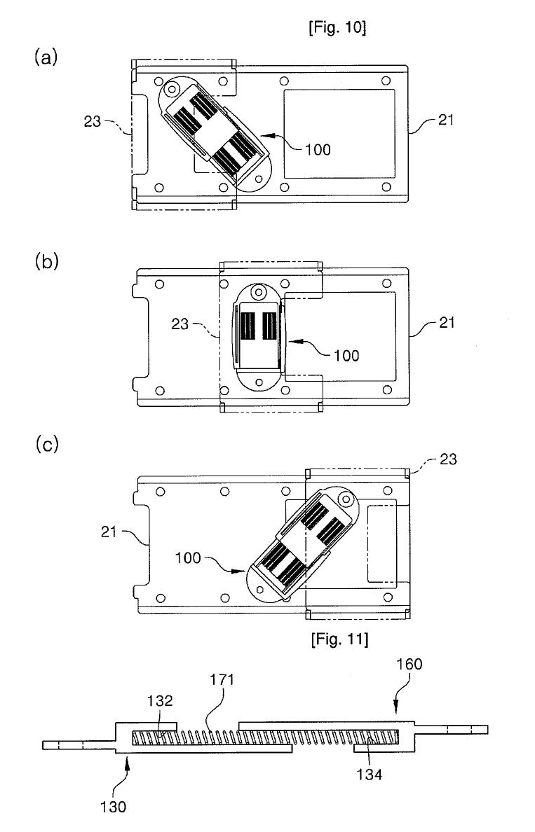

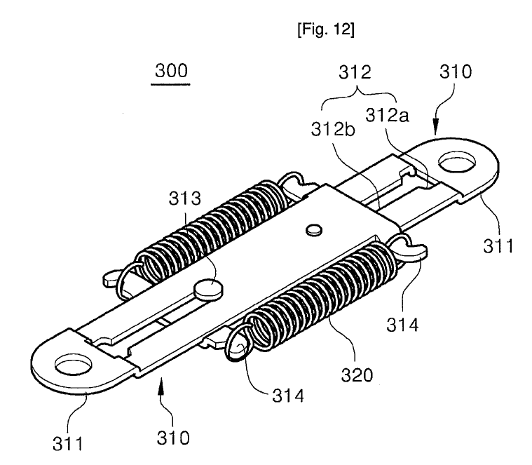

FIG. 10 is a view illustrating an operating state of the slider assembly shown in FIG. 9. The operation of the slider assembly of the present embodiment will be described hereinafter with reference to FIG. 10.

A state shown in FIG. 10 (a) is a state where the link plates are slid with respect to each other such that the total length of the restrained link plates can be maximized due to the compression force of the compression springs. If the user pushes the sliding plate 21 leftward, the sliding plate 21 is slid, as shown in FIG. 10 (b), so that the plurality of springs 70 of the link assembly 100 are compressed and the respective hinged link plates 30 and 50 are rotated. At the same time, as the pair of restrained link plates 30 and 50 are slid with respect to each other, the guide wings and grooves are overlap to thereby allow the total length of the link plates to be decreased. At this time, the corresponding guide wings and grooves allow the pair of link plates to be slid with respect to each other, and the guide protrusions and holes allow the link plates 30 and 50 not to be separated from each other but to be restrained. In the state shown in FIG. 10 (b), the compression force of the springs 70 is maximized while the extended length of the pair of link plates 30 and 50 is minimized. Since the springs 70 are compressed until the state shown in FIG. 10 (b) reaches, their length is decreased. Therefore, the user applies force to move the sliding plate 21 up to the state shown in FIG. 10 (b). However, if the sliding plate 21 is moved leftward slightly from the state shown in FIG. 10 (b), the elastic energy stored in the springs 70 causes the sliding plate 21 to be automatically moved leftward. That is, the plurality of springs 70 are stretched to pull the link plates 30 and 50 fixed to both ends thereof, and thus, the first link plate 30 fixed to the sliding plate 21 causes the sliding plate 21 to be pushed leftward, thereby allowing the sliding plate 21 to be moved toward a state shown in FIG. 10 (c). The sliding motion from the state shown in FIG. 10 (c) to the state shown in FIG. 10 (a) can be performed by repeating the same process as described above.

According to an embodiment of the present invention, the link assembly in which both ends of each tension spring are fixed to the fixing grooves of the link plates can be provided. Therefore, a flexible printed circuit board (FPCB) cannot be damaged due to the link assembly, and a thin link assembly can be easily assembled.

Further, since compression springs are accommodated in receiving grooves in accordance with an embodiment of the present invention, a thin link assembly using the compression springs can be easily assembled.

Furthermore, if a low-friction plastic is used to manufacture a link assembly according an embodiment of the present invention, the mass production of the link assembly can be realized and the smooth sliding motion thereof can also be implemented due to lower friction force between the link plates.

Moreover, a sliding-type mobile phone having the aforementioned link assembly can be slim.

The embodiments of the present invention described above and illustrated in the drawings should not be construed to limit the technical spirit of the present. The protection scope of the present invention should be limited only by the appended claims, but various modifications and changes can be made thereto by those skilled in the art without departing from the scope and spirit of the present invention. Accordingly, such various modifications and changes would be included into the protection scope of the present invention so long as they are apparent to those skilled in the art.

1-25. (canceled)

26. A handheld electronic device comprising:
a first panel;
a second panel slidable with respect to the first panel;
a first slider secured to the first panel;
a second slider secured to the second panel, wherein the second slider is slidably engaged with the first slider and slidable relative to the first slider;
a link assembly comprising:
a first link member pivotably connected to the first slider at a first pivot point thereof and comprising a slot,
a second link member pivotably connected to the second slider at a second pivot point thereof and slidably engaged with the first link member, and
a spring comprising a first end portion, a second end portion and a body between the first and second end portions, wherein the first end portion comprises a head and a neck between the head and the body, wherein at least one of the neck and the head is inserted in the slot so as to engage with the first end portion with the first link member, wherein the second end portion is engaged with the second link member.

27. The device of claim 26, wherein the first slider comprises a guide rail, the second slider comprises an edge slidably engaged with the guide rail.

28. The device of claim 26, wherein the first link member comprises a guide groove, the second link member comprises an extended body slidably engaged with the guide groove.

29. The device of claim 26, wherein the first link member comprises a first body and a first arm extending from the first body, wherein the second link member comprises a second body and a second arm extending from the second body, wherein the first and second bodies are slidably engaged with each other, wherein a distance between the first and second arms is variable when the first body slides with respect to the second body.

30. The device of claim 29, wherein the spring is configured to apply a resilient force to at least one of the first and second arms such that the distance decreases.

31. The device of claim 29, wherein the slot is a recess formed in the first arm.

32. The device of claim 26, wherein the neck comprises a wound coil of a wire.

33. The device of claim 26, wherein the body comprises a tension coil spring.

34. The device of claim 26, wherein the neck and the body are formed of a wound coil, wherein the neck has a diameter smaller than that of the head.

35. The device of claim 26, wherein the neck and the body are formed of a wound coil, wherein the neck has a diameter smaller than that of the body.

36. The device of claim 26, wherein the slot comprises a first portion configured to receive the head and a second portion configured to receive the neck, wherein the second portion is further configured to inhibit the head from being inserted.

37. The device of claim 26, wherein the second link member comprises a second slot, wherein the second end portion comprises a second head and a second neck between the second head and the body, wherein the second end portion is engaged with the second link member in which at least one of the second neck and the second head is inserted in the second slot.

38. The device of claim 26, wherein the device comprises a portable electronic device selected from the group consisting of a wireless internet device, a mobile phone, a wireless email receiver, a radio receiver, a television receiver, a calculator, an electronic dictionary or encyclopedia, a PDA and a hand-held computer.

39. The device of claim 26, wherein the first panel comprises a display, and wherein the second panel comprises an information input device.

40. A sliding mechanism for use in a handheld electronic device comprising a first panel and a second panel slidable with respect to the first panel, the sliding mechanism comprises:
a first slider configured to be fixed to the first panel;
a second slider configured to be fixed to the second panel, wherein the second slider is slidably engaged with the first slider and slidable relative to the first slider;
a link assembly comprising:
a first link member pivotably connected to the first slider at a first pivot point thereof and comprising a slot,
a second link member pivotably connected to the second slider at a second pivot point thereof and slidably engaged with the first link member, and
a spring comprising a first end portion, a second end portion and a body between the first and second end portions, wherein the first end portion comprises a head and a neck between the head and the body, wherein at least one of the neck and the head is inserted in the slot so as to engage the first end portion with the first link member, wherein the second end portion is engaged with the second link member.

41. The mechanism of claim 40, wherein the neck comprises a wound coil.

42. The mechanism of claim 40, wherein the body comprises a tension coil spring.

43. The mechanism of claim 40, wherein the neck and the body are formed of a wound coil, wherein the neck has a diameter smaller than that of the head.

44. The mechanism of claim 40, wherein the slot comprises a first portion configured to receive the head and a second portion configured to receive the neck, wherein the second portion is further configured to inhibit the head from being inserted.

45. A method of coupling a spring to a structure, the method comprising:
providing a first member comprising a slot;
providing a spring comprising a first end portion, a second end portion and a body between the first and second end portions, wherein the first end portion comprises a head and a neck between the head and the body,
inserting at least one of the neck and the head into the slot such that the first end portion is engaged with the first structure; and
engaging the second end portion with a second member so as to interconnect the first and second members via the spring.

46. The method of claim 45, wherein the neck comprises a wound coil.

47. The method of claim 45, wherein the body comprises a tension coil spring.

48. The method of claim 45, wherein the neck and the body are formed of a wound coil, wherein the neck has a diameter smaller than that of the head.

49. The method of claim 45, wherein the slot comprises a first portion configured to receive the head and a second portion configured to receive the neck, wherein the second portion is further configured to inhibit the head from being inserted.

50. The method of claim 45, wherein the second link member comprises a second slot, wherein the second end portion comprises a second head and a second neck between the second head and the body, wherein engaging the second end portion engaged with the second link member comprises inserting at least one of the second neck and the second head in the second slot.
